(19) United States
(12) Patent Application Publication
(10) Pub. No.: US 2009/0039681 A1
(43) Pub. Date: Feb. 12, 2009

(54) METHOD AND CONSTRUCTION KIT GROUP FOR THE PRODUCTION OF CHASSIS OF INDUSTRIAL TRUCKS

(75) Inventors: Rolf BOGELEIN, Crailsheim (DE); Christoph Zeidler, Landshut (DE)

Correspondence Address: ROTHWELL, FIGG, ERNST & MANBECK, P.C., 1425 K STREET, N.W., SUITE 800, WASHINGTON, DC, 20005, US

(73) Assignee: JUNGHEINRICH AKTIENGESELLSCHAFT, Hamburg (DE)

(21) Appl. No.: 12/187,595

(22) Filed: Aug. 7, 2008

(30) Foreign Application Priority Data
Aug. 7, 2007 (DE) 10 2007 037 098.0

(51) Int. Cl. B60R 27/00

(52) U.S. Cl. 296/203.01

(57) ABSTRACT

The present invention relates to a method for producing a plurality of different chassis of industrial trucks, the following steps being provided in accordance with the invention:
a) provision of a plurality of identical or different chassis base frames (10-1; 10-2; 10-3),
b) provision of different chassis counterweights (30-1; 30-2), which are prepared for the installation of a steering device (34), which is associated with the respective chassis counterweight (30-1; 30-2), from a group of different steering devices or are in each case already provided with such a steering device,
c) selection of a chassis base frame (10-1; 10-2; 10-3) and of the chassis counterweight (30-1; 30-2) to be connected to the chassis base frame to form a chassis according to a desired chassis for an industrial truck (50-1; 50-2; 52-1; 52-2),
d) assembly of the selected chassis base frame (10-1; 10-2; 10-3) with the selected chassis counterweight (30-1; 30-2) to form the chassis of the industrial truck (50-1; 50-2; 52-1; 52-2),
e) repetition of steps c) and d).

In addition, the invention relates to a construction kit group for the production of chassis of industrial trucks by the method according to the invention and to an industrial truck which is produced using a construction kit from the construction kit group.

The present invention relates to a method and a construction kit group for producing a plurality of different chassis of industrial trucks and to an industrial truck produced using such a construction kit and to a group of at least two industrial trucks.

The chassis of an industrial truck is generally formed by a base frame and a counterweight fastened on this base frame, and until now it has been conventional to fasten a steering apparatus of the industrial truck likewise on the base frame. However, in the case of industrial trucks, various steering devices are used depending on whether a single wheel or a twin wheel or two separate wheels are used on the steering device. When using a single wheel or a twin wheel, a so-called steering bolster is generally used, whereas in the embodiment with two separate wheels, a steering mechanism with a swing axle is used. This results, in the case of such counterweight stackers with conventional sizes, in three-wheel or four-wheel vehicles, the embodiment with a central rear twin wheel also being referred to as a three-wheel vehicle in the technical world. In the case of such vehicles, as has already been implicated, both the swing axle and the steering bolster are fastened on the base frame, and the counter weight is likewise fastened on this frame above the swing axle or the steering bolster.

In terms of their outward appearance and their construction, three-wheel and four-wheel vehicles therefore differ from one another primarily by their steering device and by their counterweight arranged in the region of the steering device. Optionally a counterweight for a three-wheel or four-wheel vehicle can be mounted on a base frame.

When fastening the different counterweights and the different steering devices on the base frame, it is therefore necessary for the base frames to be configured differently in their rear region, in which the mentioned component parts are fastened, depending on the steering device used and depending on the counterweight used, with it not being possible for a base frame which has been prepared for a four-wheel vehicle to be used for producing a chassis for a three-wheel vehicle.

In comparison with this, it is the object the invention to simplify the construction of a chassis for industrial trucks, with the result that a base frame can be used both for a three-wheel vehicle and for a four-wheel vehicle.

In order to achieve this object, the invention proposes a method for producing a plurality of different chassis of industrial trucks in which the following steps are provided in accordance with the invention:
a) provision of a plurality of identical or different chassis base frames,
b) provision of different chassis counterweights, which are prepared for the installation of a steering device, which is associated with the respective chassis counterweight, from a group of different steering devices or are in each case already provided with such a steering device,
c) selection of a chassis base frame and of the chassis counterweight to be connected to the chassis base frame to form a chassis according to a desired chassis for an industrial truck,
d) assembly of the selected chassis base frame with the selected chassis counterweight to form the chassis of the industrial truck,
e) repetition of steps c) and d).

Such a production method allows for the optional combination of chassis base frames with chassis counterweights, with the result that different chassis for different industrial trucks can be assembled in modular fashion. In this case, it is particularly advantageous that the steering device is provided on the chassis counterweight, which means that no corresponding fastening arrangement for the different steering devices needs to be provided on the chassis base frame, as was previously known from the prior art.

Preferred developments of the method are given in dependent claims 2 to 7.

It should be particularly emphasized here that the chassis base frames and the chassis counterweights are configured in such a way that any chassis base frame can be assembled with any chassis counterweight, with the result that any type of chassis for a desired industrial truck can be provided simply by assembling the chassis base frame and the chassis counterweight.

In this regard the invention in particular proposes that the assembly takes place at fastening points on the respective chassis base frame which are formed at the same positions in the case of all chassis base frames, and that the chassis counterweights have fastening points which at least partially correspond to the fastening points on the chassis base frames. Fastening points required for any chassis counterweight type can therefore be formed on the chassis base frame, with it being possible for certain fastening points for a plurality of chassis counterweights to be the same and for others to be different. In the case of such an embodiment of the chassis base frame, however, it is not necessary when assembling the chassis base frame and the chassis counterweight to produce further fastening points depending on the chassis counterweight to be attached. This simplifies the assembly of the chassis for a desired industrial truck.

The connection between the chassis base frame and the chassis counterweight should preferably be detachable, with possibilities being in particular a screw-type connection or a type of suspension means for the counterweight on the base frame. Such a detachable connection also makes it possible to convert an already constructed industrial truck for example from a three-wheel industrial truck to a four-wheel industrial truck, with in such a case only the corresponding counterweight with the associated steering device needing to be replaced and attached on the chassis base frame of the existing industrial truck.

The steering devices which are installed or can be installed in the different counterweights can be configured as a steering mechanism with a swing axle in the case of a four-wheel vehicle or as a steering bolster in the case of a three-wheel vehicle. These types of steering devices are very different in terms of their configuration and influence the shape of the chassis counterweight, this change in shape substantially being restricted to those regions of the chassis counterweight on which cutouts for the attachment of the steered wheels need to be provided. A front attachment region of the chassis counterweight which faces the respective chassis base frame remains largely unchanged, however, with the result that the modular design is further simplified.

In accordance with a further aspect of the invention, a construction kit group for the production of chassis of industrial trucks, in particular by the described method, is claimed. The invention provides that this construction kit group comprises a plurality of identical or different chassis base frames, which are prepared for the attachment of different chassis counterweights, the chassis counterweights being prepared for the installation of a steering device, which is associated with the respective chassis counterweight, from a group of different steering devices or in each case already being provided with such a steering device, and the chassis counterweights being designed appropriately for assembly with the chassis base frames.

A construction kit selected from this construction kit group preferably comprises a selected chassis base frame and a selected chassis counterweight as well as a steering device, which is either already installed in the chassis counterweight or is yet to be installed when the chassis is assembled.

Further advantageous configurations of the construction kit group are given in dependent claims 9 to 21.

Preferably, the chassis base frame of a construction kit is arranged in front of the chassis counterweight in the longitudinal direction of the chassis, the longitudinal direction corresponding to the direction of travel when the ready-assembled industrial truck is travelling straight on.

Preferably, non-steerable front wheels of the industrial truck are to be attached or are attached on the chassis base frame, and at least one rear wheel of the industrial truck is to be attached or is attached on the steering device of the chassis counterweight. This makes it possible to produce the desired three-wheel or four-wheel industrial trucks, with it being possible for the respective wheels to be attached on the chassis base frame or on the steering device in the chassis counterweight prior to or after assembly of the chassis base frame and the chassis counterweight.

In order to be able to ensure the corresponding modularity even in the case of the energy supply or the electronic control of the industrial truck, the invention proposes that an energy supply unit, in particular a hydraulic supply unit, for actuating a respective steering device is to be accommodated or is accommodated in the chassis base frame, this energy supply unit preferably being designed in such a way that it outputs an identical manipulated variable which is independent of the steering device used, in particular an identical effective hydraulic pressure, at its end which is on the side of the steering device. As regards the energy supply for actuating the steering device, the same energy supply unit or hydraulic supply unit can therefore be installed in the chassis base frame irrespective of the type of industrial truck, i.e. irrespective of whether the industrial truck is a three-wheel or four-wheel vehicle.

In order to be able to make optimum use of the constant manipulated variable output by the energy supply unit, in particular the same effective hydraulic pressure for the respective steering device, the invention proposes that an energy matching module, which is formed as a function of the respective steering device which is or can be installed, is accommodated or is to be accommodated in the chassis counterweight and is designed in such a way that it converts the manipulated variable output by the energy supply unit into a manipulated steering variable which is matched for the respective steering device. Such an energy matching module may be, for example, an arrangement of hydraulic component parts, in particular valves, hydraulic cylinders and the like, by means of which the manipulated variable supplied by the energy supply unit can be altered.

In addition, in order to support the modular design, the invention proposes that an interface, which can be used for all steering devices and in particular is identical to all steering devices, is provided between a control unit, which drives the energy supply unit, of the industrial truck and the energy matching module, which is matched to the respective steering device, for signal transmission to or from the control unit. Such a signal control interface simplifies the control of the finished industrial truck and the control signals output by a control unit for steering actuation are converted by the energy matching module in such a way that the respective different steering device is driven correspondingly. It is therefore not necessary to reprogram the central control unit if different steering devices are used, since the conversion of control signals influencing the steering takes place by means of the energy matching module associated with the respective steering device or the respective chassis counterweight.

The production method proposed and the construction kit group proposed therefore allow for a high degree of modularization when assembling chassis for different industrial trucks, this modularization not only being achieved in the case of the bearing components, the chassis base frame and the chassis counterweight or the steering device, but also in the case of the electronic control and the energy supply, in particular hydraulic supply.

The invention also includes an industrial truck which is produced using a construction kit from the previously described construction kit group. In addition, the invention according to claim 23 also relates to a group of at least two industrial trucks, a first industrial truck comprising a first construction kit, and a second industrial truck comprising a second construction kit, which differs from the first construction kit at least in terms of the chassis counterweight used.

The invention will be described by way of example and in non-restrictive fashion below using an embodiment with reference to the attached figures, in which:

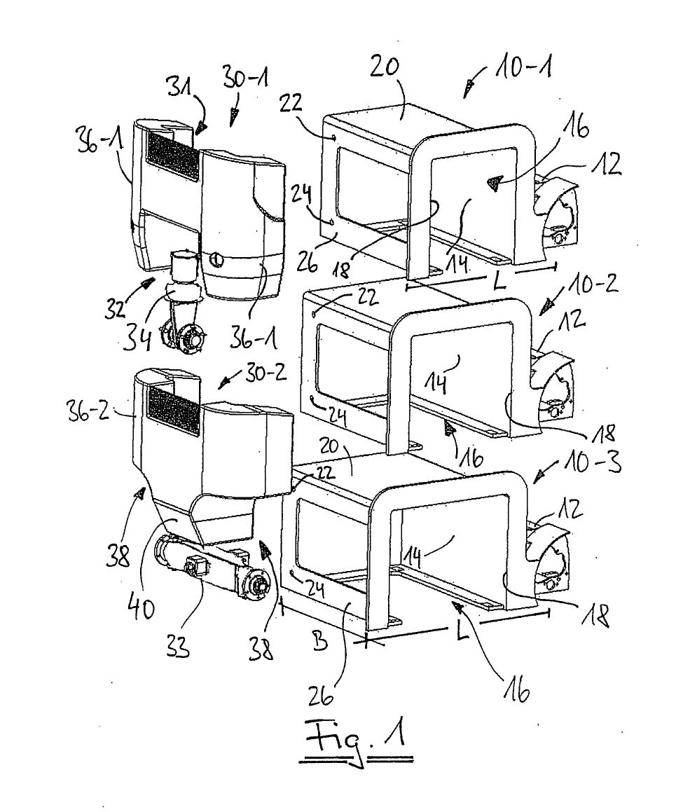

FIG. 1 shows a schematic, perspective view of two chassis counterweights with respectively associated steering devices and three chassis base frames which can be assembled with these counterweights.

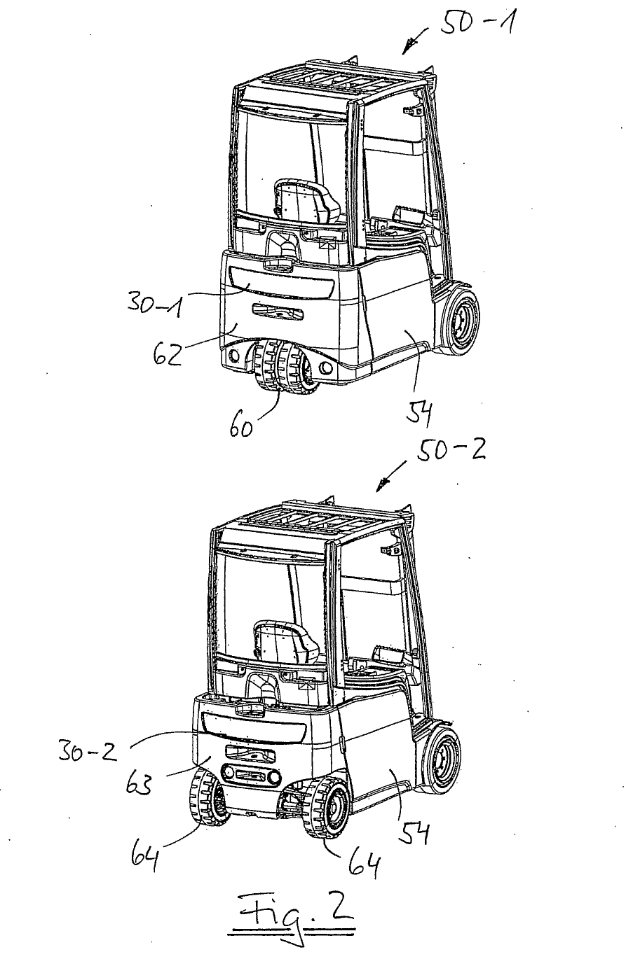

FIG. 2 shows a schematic, perspective view of a respective three-wheel and four-wheel industrial truck with a short chassis base frame.

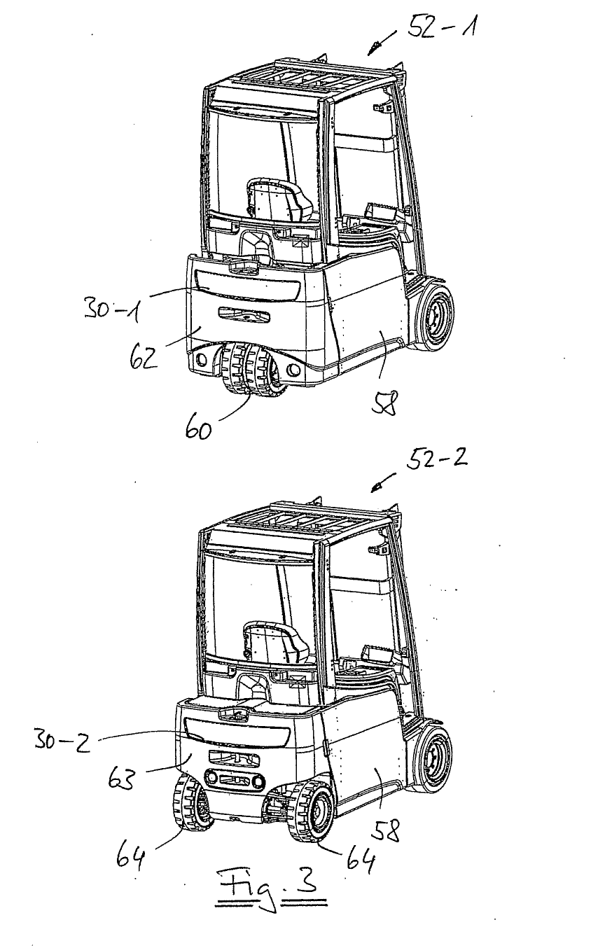

FIG. 3 shows a respective three-wheel and four-wheel industrial truck with a long chassis base frame.

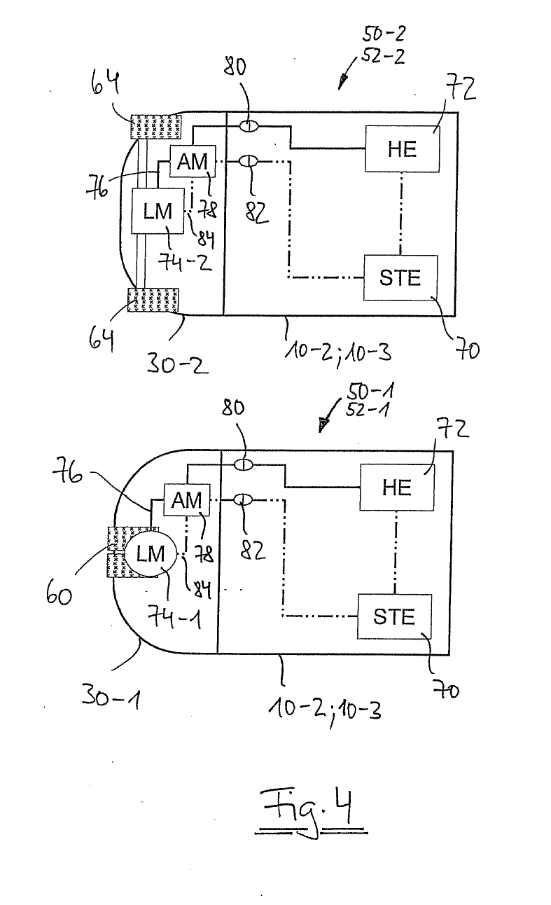

FIG. 4 shows, in a very schematized illustration, the modularization of the energy supply and electronic control for industrial trucks according to the invention.

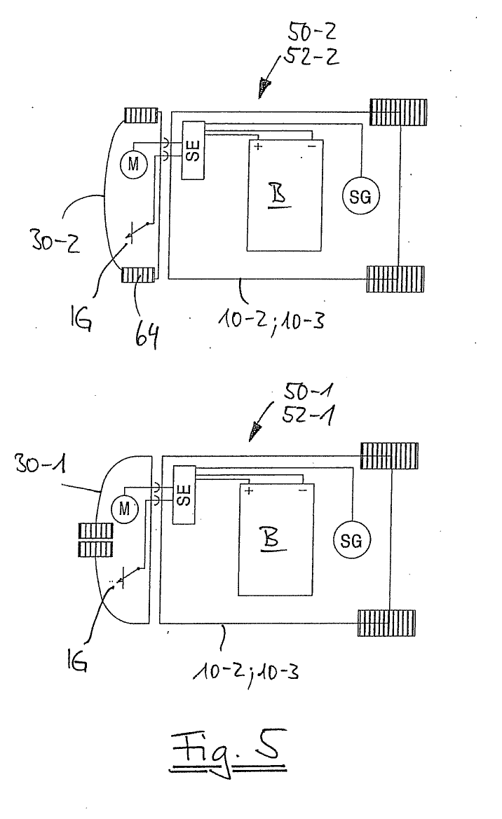

FIG. 5 shows a basic sketch of a preferred embodiment.

FIG. 1 illustrates the essential components which are required for the assembly of a chassis for an industrial truck. It illustrates three chassis base frames 10-1, 10-2 and 10-3, which only differ from one another in terms of their respective length L: base frame 10-1 is the shortest and base frame 10-3 is the longest. Depending on the industrial truck to be produced, another base frame can be selected, with the result that industrial trucks for different maximum loads can be provided. The widths B of the three base frames 10-1, 10-2, 10-3 are identical. All three base frames 10-1, 10-2 and 10-3 of different lengths comprise, in their front region, suspension sections 12, on which front wheels of the industrial truck can be attached. These suspension sections 12 are separated by a separating wall 14 from a respective battery accommodating area 16, into which a battery pack can be inserted in the lateral direction through a respective opening 18. Formed on the upper side of the battery accommodating area 16 is a cover plate 20, on which the top section of the industrial truck, in particular the cab frame, the driver's seat and the like, can be supported.

Provided in the rear region of the respective base frames 10-1, 10-2, 10-3 are fastening points 22, 24, at which a desired chassis counterweight 30-1 or 30-2 can be connected to the respective base frame 10-1, 10-2 or 10-3. These fastening points 22, 24 are only illustrated by way of example and it is naturally also possible for other fastening points to be provided on the respective base frames 10-1, 10-2 and 10-3 in order to ensure a secure connection between the respective base frames 10-1, 10-2 and 10-3 and a respective counterweight 30-1 or 30-2. In the example, the fastening points 22, 24 are in the form of through-holes, the counterweight 30-1 having, on its front side 31, fastening points which correspond to these two through-holes 22, 24 in order to make it possible for a screw connection to be provided at these two points. The counterweight 30-2, whose shape is designed to be different from that of the counterweight 30-1 by virtue result of the fact that it is prepared for the installation of a steering mechanism with a swing axle 33, will in the present example only have one fastening point corresponding to the fastening point 22. As has already been mentioned above, however, further fastening points specific to the respective counterweights 30-1 and 30-2 can be formed in the respective base frames, with the result that any counterweight 30-1 or 30-2 can be connected in optimum fashion to a respective base frame 10-1, 10-2 and 10-3. In particular it is conceivable for a further fastening point for the counterweight 30-2 to be provided between the two fastening points 22 and 24 illustrated and for yet another fastening point to be provided in the centre (in relation to the width B) of a lower frame section 26, for example, with this fastening point then not being used for the attachment of the counterweight 30-1.

Preferably, the counterweights 30-1 and 30-2 are secured with the respective base frames 10-1, 10-2 and 10-3 by means of a screw connection. However, it is also conceivable for the fastening points 22, 24 or further fastening points to be in the form of a type of hook, into which hooks the counterweights 30-1 and 30-2 can be suspended if corresponding lugs are formed on them. Such a hook connection could be interesting at least also for a type of premounting in order to achieve mutual alignment of the base frames with respect to the counterweights, with the result that, for example, mutually corresponding through-holes in the base frames or the counterweights are aligned with one another and the additional screw connection is simplified.

The counterweight 30-1 has, in relation to its width, a central, lower cut-out region 32, in which, in the final, assembled state of the industrial truck, a steering bolster 34 and steerable wheels fastened thereon are arranged. The side parts 36-1 of the counterweight 30-1 are designed to have substantially the same height as the base frame or a cladding fitted on the base frame in the final, assembled state.

The counterweight 30-2 is prepared for the installation of a steering mechanism with a swing axle 33 for a four-wheel industrial truck and has, primarily in the lower, central region, another configuration as the counterweight 30-1. The sides 36-2 are drawn down only to approximately half the height, with the result that a type of wheel house 38 is formed below for accommodating the wheels in the final, assembled state. In the central (in relation to the width), lower region 40, the counterweight 30-2 is configured such that it is closed.

FIGS. 2 and 3 illustrate respective industrial trucks 50-1, 50-2 and 52-1, 52-2. The industrial trucks 50-1 and 50-2 have a so-called central base frame 10-2, which is hidden in the illustration by a cladding or battery compartment cover 54 and is not visible, however. The industrial trucks 52-1 and 52-2 have in each case a so-called long base frame 10-3 behind the cover 58, with the result that these industrial trucks are slightly longer than the industrial trucks 50-1 and 50-2, respectively, which makes it possible for them to accommodate larger maximum loads. The industrial trucks 50-1, 50-2, 52-1 and 52-2 illustrated in FIGS. 2 and 3 have the same width and it is apparent that the industrial trucks 50-1 and 52-1 are in the form of three-wheel vehicles, with the steerable single wheel 60 being in the form of a twin wheel. Both industrial trucks 50-1 and 52-1 have the counterweight 30-1 with the steering bolster 34 installed and wheels 60 fitted thereon. The counterweight 30-1 is of course also covered by a corresponding cladding 62.

In the case of the industrial trucks 50-2 and 52-2, which are in the form of four-wheel industrial trucks, in each case one counterweight 30-2 is installed behind the cover 63, with a respective swing axle steering mechanism, on which the steerable rear wheels 64 are attached on the left and right.

It can be seen from FIGS. 2 and 3 that, when using the same base frame, a simple combination with different counterweights and steering devices is possible. It can also be seen that the same counterweights can also be fastened on other, in particular longer, base frames, with the result that a large number of possible combinations between the base frames and the counterweights is provided. This results in a modular construction of the chassis of the industrial trucks 50-1, 50-2, 52-1 and 52-2.

FIG. 4 illustrates, in very schematized form, the basic structures of the industrial trucks 50-1, 50-2, 52-1 and 52-2. In this case, an electronic control unit 70 and an energy supply unit or hydraulic unit 72 driven thereby are accommodated in the base frame 10-2 and 10-3, respectively, for all types of industrial truck. In the respective counterweight 30-1 or 30-2, in each case one steering module 74-1 or 74-2 is provided which makes it possible to steer the wheels 60 and 64, respectively, and which differ from one another in terms of their function in such a way that they actuate different types of steering mechanisms. The steering modules 74-1 and 74-2 are connected to a so-called matching module 78 via an energy supply line or hydraulic line 76. This matching module is hydraulically connected to the hydraulic unit 72 via a uniform interface 80. In addition, the matching module 78 is connected to the control unit 70 via a uniform control interface 82. The respective matching modules 78-1 and 78-2 are configured in such a way that they can convert or match the manipulated variables incoming at the unit interfaces 80 and 82, respectively, for the respective steering module 74-1 or 74-2, with the result that the steering module causes the wheels 70 and 64, respectively, to move correspondingly.

The manipulated variable provided by the hydraulic unit 72 at the interface 80 is, for example, an effective hydraulic pressure which is the same for all possible embodiments of the industrial truck and which is changed by the matching module 78-1 or 78-2 in such a way that the steering module 74-1 or 74-2 can be actuated.

At the electronic control interface 82, uniform signals for actuating the steering mechanisms are output by the control unit 70 to the respective matching modules 78-1 and 78-2, which convert these uniform signals in such a way that driving of the steering modules 74-1 and 74-2, respectively, can take place via the signal line 84. The interfaces 80 and 82 are in the form of detachable interfaces, with the result that they make the desired modular design of industrial truck chassis possible and the assembly of the base frames and the counterweights is simplified. The hydraulic unit 72 accommodated in the base frame 10-2 and the electronic control unit 70 naturally have further lines which are used for driving the lifting apparatus or the vehicle drive apparatus.

The proposed production method and the proposed construction kit group therefore result overall in a modular design both for the mechanical component parts, namely the base frame, the counterweight and the steering device, and for the hydraulic or control engineering component parts, with both mechanical interfaces (see FIG. 1, fastening points 22, 24) and hydraulic or control engineering interfaces 80, 82 being provided which allow for simple and unproblematic assembly of the base frames and counterweights in order to produce different industrial trucks.

Overall, assembly of an industrial truck is simplified hereby and in addition the control can be simplified since no or only little reprogramming needs to take place in the programming of the central control unit 70 depending on the type of steering mechanism used, with the result that there are fewer different parts for the two main vehicle types, namely the three-wheel vehicle and the four-wheel vehicle, and in addition also fewer different parameters need to be set on the two vehicle types. Finally, the proposed design also allows for retrospective conversion of a three-wheel vehicle to a four-wheel vehicle, or vice versa.

FIG. 5 is a basic sketch which supplements the schematic illustration in FIG. 4 and reproduces the design in a preferred embodiment of an industrial truck by the applicant. The schematically illustrated industrial trucks 50-2, 52-2 (four-wheel vehicle) and 50-1, 52-1 (three-wheel vehicle) each comprise a setpoint generator SG (steering wheel), a control unit SE (steering control), an actuating unit M in the form of an actuator (steering motor) and an actual-value sensor IG (steering deflection sensor). The steering motor M accommodated in the respective counterweight 30-1 or 30-2 preferably has the same configuration in all vehicles. In the case of the three-wheel embodiment 50-1, 52-1, a rotary movement of the steering motor M is converted into a rotation of the steering bolster 34 (FIG. 1). In the case of the four-wheel industrial truck 50-2, 52-2, the rotary movement of the steering motor M is transferred to a hydraulic pump, which drives the swing axle of the steering mechanism. However, it is also conceivable in the case of a four-wheel industrial truck 50-2, 52-2 for an electromechanical linear drive (spindle drive) to be used instead of a hydraulic steering cylinder in order to achieve the steering movement of the wheels 64. The actual-value sensor IG ideally transmits the same electrical signal to the control unit SE in the case of both types of industrial truck given a corresponding steering deflection. However, the actual-value sensors can also be designed to be different. A further possibility for taking into consideration differences in the sensing of the steering deflections of the various steering devices consists in providing a different connector pin assignment such that, depending on the steering device installed, other electronic switching paths between the control unit SE and the actual-value sensor IG can be interconnected. For reasons of completeness, reference is made to the fact that the basic illustrations in FIG. 5 illustrate a battery pack B accommodated in the respective industrial truck with the corresponding connection terminals.

1. Method for producing a plurality of different chassis of industrial trucks (50-1; 50-2; 52-1; 52-2), characterized by the following steps:
a) provision of a plurality of identical or different chassis base frames (10-1; 10-2; 10-3),
b) provision of different chassis counterweights (30-1; 30-2), which are prepared for the installation of a steering device (34), which is associated with the respective chassis counterweight (30-1; 30-2), from a group of different steering devices or are in each case already provided with such a steering device,
c) selection of a chassis base frame (10-1; 10-2; 10-3) and of the chassis counterweight (30-1; 30-2) to be connected to the chassis base frame to form a chassis according to a desired chassis for an industrial truck (50-1; 50-2; 52-1; 52-2),
d) assembly of the selected chassis base frame (10-1; 10-2; 10-3) with the selected chassis counterweight (30-1; 30-2) to form the chassis of the industrial truck (50-1; 50-2; 52-1; 52-2),
e) repetition of steps c) and d).

2. Method according to claim 1, characterized in that the different chassis counterweights (30-1; 30-2) have a different shape depending on the steering device (33; 34) installed.

3. Method according to claim 2, characterized in that the chassis base frames (10-1; 10-2; 10-3) and the chassis counterweights (30-1; 30-2) are configured in such a way that any chassis base frame (10-1; 10-2; 10-3) can be assembled with any chassis counterweight.

4. Method according to claim 3, characterized in that the assembly takes place at fastening points (22, 24) on the respective chassis base frame (10-1; 10-2; 10-3) which are formed at the same positions in the case of all chassis base frames (10-1; 10-2; 10-3).

5. Method according to claim 4, characterized in that the chassis counterweights (30-1; 30-2) have fastening points which at least partially correspond to the fastening points (22, 24) on the chassis base frames (10-1; 10-2; 10-3).

6. Method according to claim 1, characterized in that a respective chassis base frame (10-1; 10-2; 10-3) is detachably connected, in particular screwed, to a respective chassis counterweight (30-1; 30-2).

7. Method according to claim 1, characterized in that the steering devices (33; 34) which are installed or can be installed in the different chassis counterweights (30-1; 30-2) are configured as a steering mechanism with a swing axle (33) or as a steering bolster (34).

8. Construction kit group for the production of chassis of industrial trucks, in particular by the method according to claim 1, characterized by a plurality of identical or different chassis base frames (10-1; 10-2; 10-3), which are prepared for the attachment of different chassis counterweights (30-1; 30-2), the chassis counterweights (30-1; 30-2) being prepared for the installation of a steering device (34), which is associated with the respective chassis counterweight (30-1; 30-2), from a group of different steering devices or in each case already being provided with such a steering device, and the chassis counterweights (30-1; 30-2) being designed appropriately for assembly with the chassis base frames (10-1; 10-2; 10-3).

9. Construction kit group according to claim 8, characterized in that a construction kit comprises a selected chassis base frame (10-1; 10-2; 10-3) and a selected chassis counterweight (30-1; 30-2) with a steering device (33; 34).

10. Construction kit group according to claim 8, characterized in that the different chassis counterweights (30-1; 30-2) have a different shape depending on the steering device (33; 34) installed.

11. Construction kit group according to claim 10, characterized in that the chassis base frames and the chassis counterweights (30-1; 30-2) are configured in such a way that any chassis base frame (10-1; 10-2; 10-3) can be assembled with any chassis counterweight (30-1; 30-2).

12. Construction kit group according to claim 11, characterized in that the chassis base frames (10-1; 10-2; 10-3) have fastening points (22, 24) which are formed at the same positions in the case of all chassis base frames (10-1; 10-2; 10-3).

13. Construction kit group according to claim 12, characterized in that the chassis counterweights 30-1; 30-2) have fastening points (22, 24) which at least partially correspond to the fastening points (22, 24) on the chassis base frames (10-1; 10-2; 10-3).

14. Construction kit group according to claim 8, characterized in that in a construction kit the respective chassis base frame (10-1; 10-2; 10-3) is detachably connected, in particular screwed, to the respective chassis counterweight (30-1; 30-2).

15. Construction kit group according to claim 8, characterized in that the chassis base frame (10-1; 10-2; 10-3) of a construction kit is arranged in front of the chassis counterweight (30-1; 30-2) in the longitudinal direction of the chassis.

16. Construction kit group according to claim 1, characterized in that the steering device (33; 34) is in the form of a steering mechanism with a swing axle (33) or in the form of a steering bolster (34).

17. Construction kit group according to claim 16, characterized in that non-steerable front wheels of the industrial truck (50-1; 50-2; 52-1; 52-2) are to be attached or are attached on the chassis base frame (10-1; 10-2; 10-3), and in that at least one rear wheel (60; 64) of the industrial truck (50-1; 50-2; 52-1; 52-2) is to be attached or is attached on the steering device (34) of the chassis counterweight (30-1; 30-2).

18. Construction kit group according to claim 1, characterized in that an energy supply unit (72), in particular a hydraulic supply unit, for actuating a respective steering device (33; 34) is to be accommodated or is accommodated in the chassis base frame (10-1; 10-2; 10-3).

19. Construction kit group according to claim 18, characterized in that the energy supply unit (72) is designed in such a way that it emits an identical manipulated variable which is independent of the steering device (33; 34) used, in particular an identical effective hydraulic pressure, at its end (80) which is on the side of the steering device.

20. Construction kit group according to claim 19, characterized in that an energy matching module (78), which is formed as a function of the respective steering device (33; 34) which is or can be installed, is accommodated or is to be accommodated in the chassis counterweight (30-1; 30-2) and is designed in such a way that it converts the manipulated variable output by the energy supply unit (72) into a manipulated steering variable which is matched for the respective steering device (33; 34).

21. Construction kit group according to claim 20, characterized in that an interface (82), which can be used for all steering devices (33; 34) and in particular is identical for all steering devices (33; 34), is provided between a control unit (70), which drives the energy supply unit (72), of the industrial truck (50-1; 50-2; 52-1; 52-2) and the energy matching module (78), which is matched to the respective steering device (33; 34), for signal transmission to or from the control unit (70).

22. Industrial truck produced using a construction kit from a construction kit group according to claim 8.

23. Group of at least two industrial trucks according to claim 22, a first industrial truck (50-1; 52-1) comprising a first construction kit, and a second industrial truck. (50-2; 52-2) comprising a second construction kit, which differs from the first construction kit at least in terms of the chassis counterweight (30-2) used.
